(19) United States
(12) Patent Application Publication
(10) Pub. No.: US 2007/0023656 A1
(43) Pub. Date: Feb. 1, 2007

(54) Method for inspecting substrate, and method and apparatus for inspecting array substrates

(76) Inventor: Satoru Tomita, Kawagoe-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/512,352

(22) Filed: Aug. 30, 2006

Related U.S. Application Data
(63) Continuation of application No. PCT/JP05/02815, filed on Feb. 22, 2005.

(30) Foreign Application Priority Data
Mar. 5, 2004 (JP) 2004-062654

(51) Int. Cl. G21K 7/00

(52) U.S. Cl. 250/310

(57) ABSTRACT

A method for inspecting a substrate comprising a mother substrate, a first array area and a second array area which are formed on the mother substrate and opposed to each other with respect to a line intended for division, and each of which includes scanning lines, signal lines, switching elements close to intersections of the scanning lines and the signal lines, and pixel electrodes connected to the switching elements, the method comprising radiating electron beams onto a radiation area which includes at least part of the first array area and at least part of the second array area, with a relative positional relationship between the mother substrate and the beam source being fixed at the same time, detecting secondary electrons radiated from the pixel electrodes, and inspecting with respect to whether the pixel electrodes are defective or not based on the detected secondary electrons.

### CROSS-REFERENCE TO RELATED APPLICATIONS

This is a Continuation Application of PCT Application No. PCT/JP2005/002815, filed Feb. 22, 2005, which was published under PCT Article 21(2) in Japanese.

This application is based upon and claims the benefit of priority from prior Japanese Patent Application No. 2004-062654, filed Mar. 5, 2004, the entire contents of which are incorporated herein by reference.

### BACKGROUND OF THE INVENTION

1. Field of the Invention

The present invention relates to a method for inspecting a substrate which is a structural element of a liquid crystal display device, and a method and an apparatus for inspecting array substrates.

2. Description of the Related Art

A liquid crystal display device is applied to various portions such as a display section of a notebook computer (notebook PC), that of a cellular phone, and that of a television receiver. The liquid crystal display device includes an array substrate wherein a plurality of pixel electrodes are arranged in a matrix, an opposite substrate including opposite electrodes arranged opposite to the pixel electrodes, and a liquid crystal layer held between the array substrate and the opposite substrate.

The array substrate includes the pixel electrodes arranged in the matrix, a plurality of scanning lines arranged along rows of the plural pixel electrodes, a plurality of signal lines arranged along columns of the plural pixel electrodes, and a plurality of switching elements arranged in the vicinity of intersections of the scanning lines and the signal lines.

As the array substrate, two types of array substrates are known, which are, i.e., an array substrate in which a switching element is a thin film transistor employing a thin semiconductor film formed of amorphous silicon, and an array substrate in which a switching element is a thin film transistor employing a thin semiconductor film formed of polysilicon. Polysilicon has a higher carrier mobility than amorphous silicon. It should be noted that a polysilicon type of array substrate can incorporate not only a switching element for pixel electrodes, but also a driving circuit for scanning lines and signal lines.

The above array substrate is subjected to an inspection step in order to detect whether it is defective or not. As an inspecting method and an inspecting apparatus, techniques disclosed in Jpn. Pat. Appln. KOKAI Publication No. 11-271177, Jpn. Pat. Appln. KOKAI Publication No. 2000-3142 and U.S. Pat. No. 5,268,638 are provided.

Jpn. Pat. Appln. KOKAI Publication No. 11-271177 discloses a technique in which inspection of an amorphous type of LCD (Liquid Crystal Display) substrate resides in, especially a point defect inspecting process. This technique utilizes a phenomenon that when direct light of a direct-current component is applied to the entire surface of the LCD substrate, an amorphous silicon film reacts to light, and becomes conductive. It can be determined whether or not the substrate is defective, by detecting the amount of leakage of charge accumulated in an auxiliary capacitor. The technique disclosed in Jpn. Pat. Appln. KOKAI Publication No. 2000-3142 utilizes a phenomenon that when an electron beam is emitted onto a pixel electrode, emitted secondary electrons are proportional to a voltage applied to a thin film transistor. The technique disclosed in U.S. Pat. No. 5,268,638 also utilizes secondary electrons which are emitted when an electron beam is emitted onto a pixel electrode.

### BRIEF SUMMARY OF THE INVENTION

As described above, in a manufacturing process of a liquid crystal display device, it is indispensable that an array substrate is subjected to an inspecting step. However, the inspecting time required in the inspecting step is long. It is therefore required to improve the efficiency.

In view of the above circumstances, an object of the present invention is to provide a method for inspecting a substrate, and a method and an apparatus for inspecting array substrates, which can shorten the time required for inspecting the array substrates, and is thus effective in lowering the prices of products.

According to an embodiment of the present invention, there is provided a method for inspecting a substrate comprising a mother substrate, a first array area and a second array area which are formed on the mother substrate and opposed to each other with respect to a line intended for division, and each of which includes scanning lines, signal lines, switching elements close to intersections of the scanning lines and the signal lines, and pixel electrodes connected to the switching elements, the method comprising:

radiating electron beams onto a radiation area which includes at least part of the first array area and at least part of the second array area, with a relative positional relationship between the mother substrate and the beam source being fixed at the same time;

detecting secondary electrons radiated from the pixel electrodes; and

inspecting with respect to whether the pixel electrodes are defective or not based on the detected secondary electrons.

According to another embodiment of the present invention, there is provided a method for inspecting mother substrate, in which a plurality of array substrate portions are formed in the mother substrate and include pixel areas in which scanning lines and signal lines are formed to intersect each other, a plurality of pixel portions are respectively formed close to intersections of the scanning lines and the signal lines, a scanning line driving circuit is formed for supplying drive signals to the pixel portions, a signal line driving circuit is formed for supplying drive signals to the pixel portions, and group of pads connected to the scanning line driving circuit and the signal line driving circuit, the method comprising:

radiating electron beams with electron beam scanning at a radiation range in which the beam scanning is performed over portions of the array substrate portions which are located opposite to each other or the beam scanning is performed over all the array substrate portions at the same time; and

acquiring inspection information on the pixel portions of the array substrate portions which are located in the radiation range.

According to another embodiment of the present invention, there is provided an apparatus for inspecting mother substrate, in which a plurality of array substrate portions are formed in the mother substrate and include pixel areas in which scanning lines and signal lines are formed to intersect each other, a plurality of pixel portions are respectively formed close to intersections of the scanning lines and the signal lines, a scanning line driving circuit is formed for supplying drive signals to the pixel portions, a signal line driving circuit is formed for supplying drive signals to the pixel portions, and group of pads connected to the scanning line driving circuit and the signal line driving circuit, the apparatus comprising:

an electron beam scanner for radiating electron beams with electron beam scanning at a radiation range in which the beam scanning is performed over portions of the array substrate portions which are located opposite to each other or the beam scanning is performed over all the array substrate portions at the same time; and

signal analyzing section for acquiring inspection information on the pixel portions of the array substrate portions which are located in the radiation range.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view for use in explaining the underlying technique of the present invention and the basic structure of an amorphous silicon type of array substrate;

FIG. 2 is a view for use in explaining the underlying technique of the present invention and the basic structure of a polysilicon type of array substrate;

FIG. 3 is a schematic vertical-sectional view of a liquid crystal display panel according to an embodiment of the present invention;

FIG. 4 is a perspective view of part of the above liquid crystal display device;

FIG. 5 is a view for use in explaining an example of arrangement of array substrate portions on a mother substrate;

FIG. 6 is a view schematically showing one of array substrates according to the embodiment of the present invention;

FIG. 7 is a schematic plan view enlargedly showing part of a pixel area in the array substrate shown in FIG. 6;

FIG. 8 is a schematic vertical-sectional view of the liquid crystal display panel, which is provided with the array substrate shown in FIG. 7;

FIG. 9 is a view for use in explaining the basic structure and operation of an electron beam taster according to the embodiment of the present invention;

FIG. 10 is a view for use in explaining the structure and operation of an inspecting apparatus for an array substrate portion, which includes the electron beam taster, according to the embodiment of the present invention;

FIG. 11 is a view for use in explaining an example of arrangement of the array substrate portions on the mother substrate, which are to be inspected;

FIG. 12 is a flowchart for use in explaining an inspecting method according to the embodiment of the present invention;

FIG. 13 is a block diagram for use in explaining processing performed in a signal analyzing section and a controlling section, in the flowchart in FIG. 12; and

FIG. 14 is a flowchart for use in explaining the inspecting method according to the embodiment of the present invention.

### DETAILED DESCRIPTION OF THE INVENTION

A method for inspecting a substrate, and a method and an apparatus for inspecting array substrates, according to an embodiment of the present invention, will be explained with reference to the accompanying drawings.

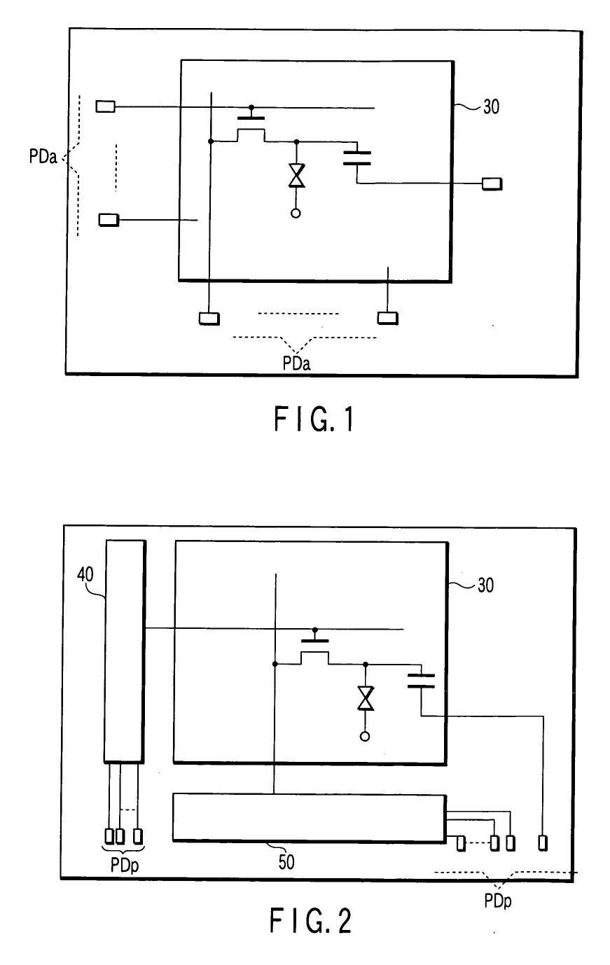

First, the underlying technique of the present invention will be explained. As shown in FIGS. 1 and 2, as the array substrate, an amorphous silicon type of array substrate and a polysilicon type of array substrate are present. For example, in an XGA (eXtended Graphics Array), the amorphous silicon type of array substrate includes a pixel area 30 and groups of pads PDa having respective terminals, for connection of an external circuit, the number of which is approximately 3000. On the other hand, in the polysilicon type of array substrate, in addition to a pixel region 30, a scanning line driving circuit 40 and a signal line driving circuit 50 are provided to drive the pixels arranged at all X and Y coordinates, and they are each formed of a thin film transistor (which will be hereinafter referred to as TFT). Therefore, the total number of terminals of groups of pads PDp is approximately 300, since it suffices that they are set for inputs of the scanning line driving circuit 40 and the signal line driving circuit 50.

The array substrate needs to be inspected in a manufacturing process. As testers for inspecting the state of the pixel area 30, an electrical tester and an electron beam tester (which will be hereinafter referred to as EB tester) are provided. Inspection using the electrical tester is performed by reading out, after accumulating the charge in an auxiliary capacitor of a pixel portion, the accumulated charge by using a probe. Inspection using the EB tester is performed as follows: after accumulating charge in an auxiliary capacitor of pixels, an electron beam is emitted onto the pixel portion, and emitted secondary electrons are detected.

In the case where the amorphous silicon type of array substrate is inspected by using the electrical tester, the number of probes for use in this inspection is approximately 3000. This is very expensive, since the prices of the probes are very high. In the case where the polysilicon type of array substrate is inspected by using the electrical tester, the number of probes for use in this inspection is approximately 300. Although the number of probes is reduced, the inspection cannot be satisfactorily performed, since it is done by using the scanning line driving circuit 40 and the signal line driving circuit 50. In addition, signal processing for the inspection is complicated.

On the other hand, in the case where the amorphous silicon type of array substrate is inspected by using the EB tester, charge is accumulated in the auxiliary capacitor of the pixel portion from common probes through the groups of pads PDp, and inspection using the EB tester is then performed. Also, in the case where the polysilicon type of array substrate is inspected by using the EB tester, charge can be accumulated in the auxiliary capacitor of the pixel portion through the scanning line driving circuit 40 and the signal line driving circuit 50. However, unlike the amorphous silicon type of array substrate, charge cannot be easily accumulated by using common probes, since the groups of pads PDp have various terminals for different input signals.

The above explanation is given of, as examples of the inspecting method, the four cases where the amorphous silicon type of array substrate is inspected by using the electrical tester, where it is by using the EB tester, where the polysilicon type of array substrate is by using the electrical tester, and where it is by using the EB tester.

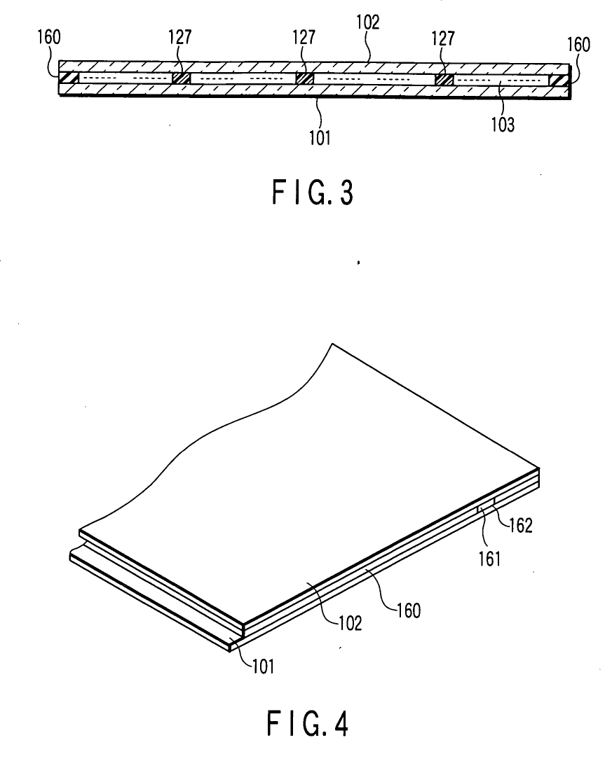

A liquid crystal display device provided with the polysilicon type of array substrate will be explained with reference to FIGS. 3 and 4. In the following explanation, the polysilicon type of array substrate will be referred to as an array substrate 101. As shown in FIGS. 3 and 4, the liquid crystal display device comprises the array substrate 101, an opposite substrate 102 arranged opposite to the array substrate by retaining a predetermined gap from the array substrate, and a liquid crystal layer 103 held by those substrates. The array substrate 101 and the opposite substrate 102 retain a predetermined gap by pillar-shaped spacers 127 serving as spacers. A peripheral portion of the array substrate 101 and that of the opposite substrate 102 are bonded to each other by a seal member 160. A liquid crystal inlet 161 formed at a part of the seal member is sealed by a sealant 162.

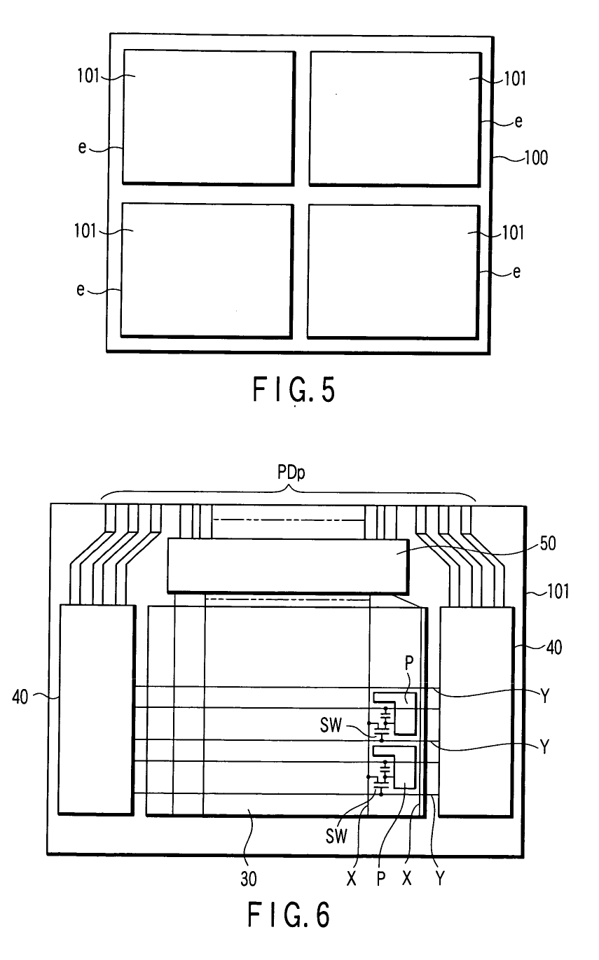

FIG. 5 shows that a plurality of array substrate portions 101, 101, . . . formed on a mother substrate 100. They will be hereinafter referred to as array substrate portions when they are provided on the mother substrate 100, and will be hereinafter referred to as array substrates when the mother substrate 100 is cut along cut lines e into the array substrate portions such that they are provided independently.

FIG. 6 representatively shows a single array substrate 101 as one of the array substrates cut off from the mother substrate 100. At one side of the array substrate 101, a regular group of pads PDp are formed. The regular group of pads PDp are connected to the scanning line driving circuit 40 and the signal line driving circuit 50. The regular group of pads PDp are used in inputting different signals, and also inputting and outputting signals for inspection.

In the pixel area 30 on the array substrate 101, a plurality of pixel electrodes P are arranged in a matrix. Besides the pixel electrodes P, the array substrate 101 comprises a plurality of scanning lines Y arranged along rows of pixel electrodes P and a plurality of signal lines X arranged along columns of pixel electrodes P. Furthermore, the array substrate 101 comprises TFTs SW arranged close to intersections of the scanning lines Y and signal lines X as switching elements, the scanning line driving circuit 40 which drives the plural scanning lines, and the signal line driving circuit 50 which drives the plural signal lines.

Each of the TFTs SW applies a signal voltage of an associated signal line X to an associated pixel electrode P, when it is driven through an associated scanning line Y. The scanning line driving circuit 40 and the signal line driving circuit 50 are arranged adjacent to end portions of the array substrate 101, and are located outward of the pixel area 30. Also, the scanning line driving circuit 40 and the signal line driving circuit 50 are each formed of TFTs which is using a polysilicon semiconductor film as in the TFTs SW.

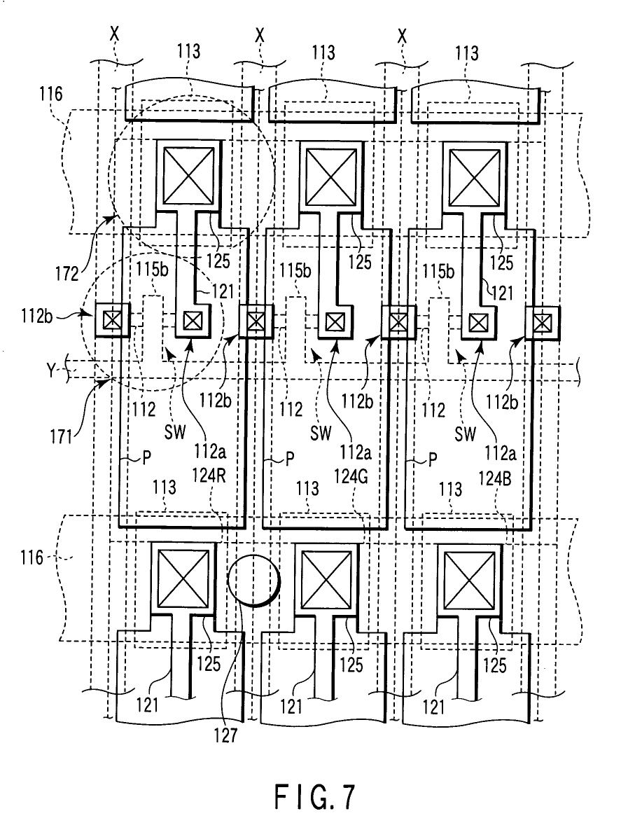

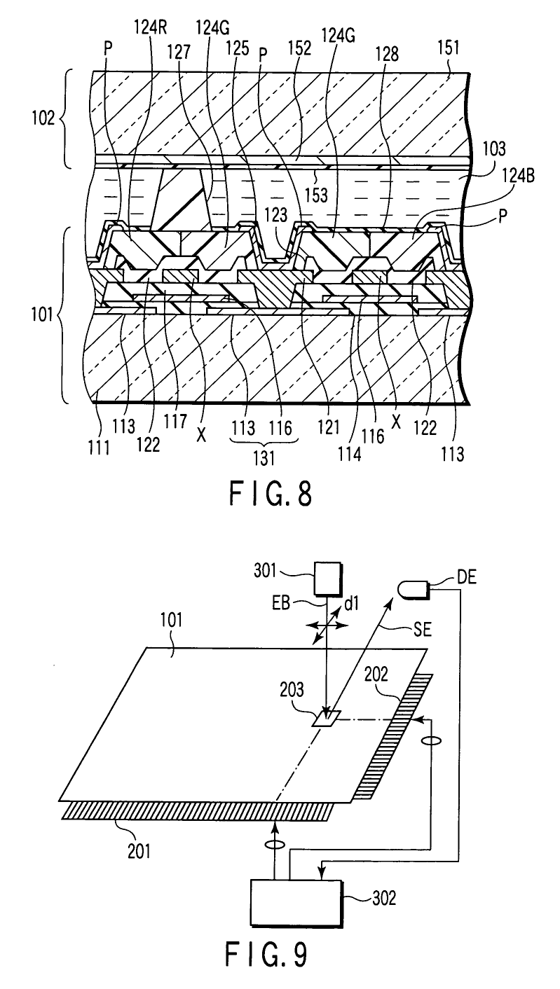

Part of the pixel area 30 shown in FIG. 6 will be explained with reference to FIGS. 7 and 8. FIG. 7 is a plan view, and FIG. 8 is a vertical sectional view. The array substrate 101 has a substrate 111 as a transparent insulating substrate (glass) (FIG. 8). In the pixel area 30, on the substrate 111, the signal lines X and scanning lines Y are arranged in a matrix, and the TFTs SW (a portion surrounded by a circle 171 should be referred to in FIG. 7) are provided at intersection portions of the scanning lines and signal lines.

The TFTs SW each comprise a semiconductor film 112 having source/drain regions 112a and 112b, and a gate electrode 115b formed by extending a part of the scanning line Y. Furthermore, on the substrate 111, stripe-shaped auxiliary capacity lines 116 are formed to form auxiliary capacity elements 131 and are extended parallel to the scanning lines Y. In those portions, the pixel electrodes P are formed (see a portion surrounded by a circle 172 in FIG. 7, and also FIG. 8).

To be more specific, on the substrate 111, the semiconductor films 112 and auxiliary capacity lower electrodes 113 are formed. On the substrate including the semiconductor films and the auxiliary capacity lower electrodes 113, gate insulating film 114 is formed. The auxiliary capacity lower electrodes 113 are formed of polysilicon as in the semiconductor films 112. On the gate insulating film 114, the scanning lines Y, gate electrodes 115b and auxiliary capacity lines 116 are provided. The auxiliary capacity lines 116 and the auxiliary capacity lower electrodes 113 are arranged opposite to each other via the gate insulating film 114. Further, interlayer insulating films 117 is formed on the gate insulating film 114 including the scanning lines Y, the gate electrodes 115b and the auxiliary capacity lines 116.

On the interlayer insulating film 117, contact electrodes 121 and the signal lines X are formed. The contact electrodes 121 are connected to the source/drain regions 112a of the semiconductor film 112 and the pixel electrodes P through contact holes. The signal lines X are connected to the source/drain regions 112b of the semiconductor films through contact holes.

Protection insulating film 122 is formed to be stacked on the contact electrodes 121, the signal lines X and the interlayer insulating film 117. Furthermore, on the protection insulating film 122, stripe colored layers, i.e., green-colored layers 124G, red-colored layers 124R and blue-colored layers 124B, are alternately arranged adjacent to each other to form a color filer.

On the colored layers 124G, 124R and 124B, the pixel electrodes P are formed of transparent conductive films such as ITO (indium, tin and oxide). The pixel electrodes P are connected to the contact electrodes 121 through contact holes 125 formed in the colored layers and the protection insulating film 122. Peripheral portions of the pixel electrodes P are located to be stacked on the auxiliary capacity lines 116 and the signal lines X. Auxiliary capacity elements 131 connected to the pixel electrodes P function as auxiliary capacities for accumulating charge.

On the colored layers 124R and 124G, the pillar-shaped spacer 127 (see FIG. 7) is formed. Although not all the pillar-shaped spacers 127 are shown, they are formed on the colored layers at a desired density. On the colored layers 124G, 124R and 124B and the pixel electrodes P, An alignment film 128 is formed. The opposite substrate 102 includes a substrate 151 as a transparent insulating substrate. On the substrate 151, an opposite electrode 152 formed of transparent material such as ITO and an alignment film 153 are successively provided.

A basic matter of the method for inspecting the array substrate 101 by using the EB tester will be explained with reference to FIG. 9. This inspection is performed after forming the pixel electrodes P on the substrate.

First, probes connected to a signal generator and signal analyzer 302 are connected to respective pads 201 and 202. Driving signals output from the signal generator and signal analyzer 302 are supplied to pixel portions 203 through probes and pads 201 and 202. After the driving signals are supplied to the pixel portions 203, an electron beam EB is radiated from an electron-beam source 301 onto the pixel portions 203.

Due to this radiation, secondary electrons SE indicating the voltages of the pixel portions 203 are radiated, and detected by an electron detector DE. The secondary electrons SE are proportional to the voltage of a portion from which they are radiated. In an inspection step, pixel portions 203 of the array substrate 101 are electrically scanned with driving signals from the signal generator and signal analyzer 302. This scanning is carried out in synchronism with scanning of the electron beams EB over the surface of the array substrate 101, which is indicated by arrows d1. The range of radiation of the electron beams EB is a circular range. This range is limited to a range in which the electron beam EB can be radiated over the entire area of a 15-inch diagonal screen.

Information indicated by the secondary electrons detected by the electron detector DE is sent to the signal generator and signal analyzer 302 for the purpose of analyzing the pixel portions 203. Furthermore, the information of the secondary electrons supplied to the signal generator and signal analyzer 302 reflects responding performance of each pixel portion to the driving signals supplied to the terminals of TFT of each pixel portion 203. Thereby the state of the voltage of the pixel electrodes P in each pixel portion 803 can be inspected. In other words, if the pixel portion 203 has a defect, the defect can be detected by the EB tester.

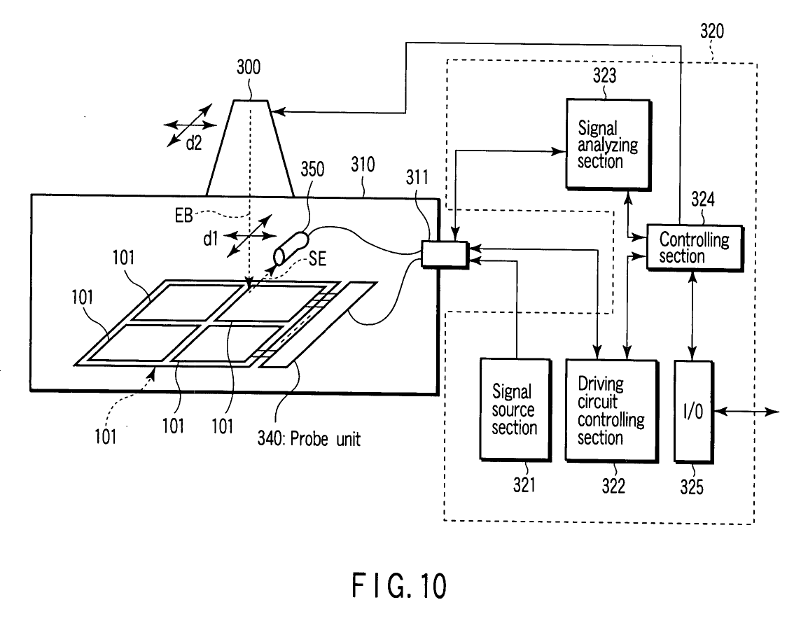

A method and an apparatus for inspecting the array substrate portions 101 by using the EB tester, according to the present invention, will be explained with reference to FIG. 10. First, the structure of the inspecting apparatus for use in inspecting the array substrate portions 101 will be explained. This inspecting apparatus incorporates the electron beam taster such that they are provided as a single body. At a vacuum chamber 310, an electron beam scanner 300 is provided. The electron beam scanner 300 is provided to be movable (in directions indicated by arrows d2), while keeping the inside of the vacuum chamber 310 in an airtight state. The electron beam scanner 300 may be located in the vacuum chamber 310, and be controlled therein with respect to movement. The mother substrate 100 can be located in the vacuum chamber 310, and also removed therefrom. Further, in the vacuum chamber 310, an electron detector 350 is provided. Furthermore, in the vacuum chamber 310, a probe unit 340 is provided, and can bring a number of probes into contact with associated pads of array substrate portions 101. The above units are controlled by a robot not shown with a high accuracy.

At a side wall of the vacuum chamber 310, a seal connector 311 is provided. The seal connector 311 is intended to connect the probe unit 340 and the electron detector 350 in the vacuum chamber 310 to respective associated external units, while keeping the inside of the vacuum chamber 310 in an airtight state. Further, a control device 320 is located outside the vacuum chamber 310. The control device 320 comprises a signal source section 321, a driving circuit controlling section 322, a signal analyzing section 323, a controlling section 324 for those sections, and an input/output section 325.

The controlling section 324 controls the driving circuit controlling section 322, and can inspect driving circuits on the array substrate portions 101 through the probe unit 340. An inspection result signal fetched from the probe unit 340 is input to the driving circuit controlling section 322. Then, the inspection result signal is fetched from the driving circuit controlling section 322 to the controlling section 324, and is output to an external device, e.g., a display device, through the input/output section 325. Furthermore, the driving circuit controlling section 322 can drive elements on the array substrate portions 101 through the regular groups of pads on the array substrate portions 101. At this time, a signal from the signal source section 321 is also given to the regular groups of pads on the array substrate portions, to thereby charge the auxiliary capacities of the pixel portions.

The controlling section 324 can control the electron beam scanner 300, and cause the pixel portions of the array substrate portions 101 to be electron-scanned. At this time, secondary electrons radiated from the pixel portions are detected by the electron detector 350, and detection information on this detection is sent to the signal analyzing section 323. The signal analyzing section 323 analyzes the detection information from the electron detector 350, and refers to position information (the addresses of detected pixels) from the controlling section 324, to thereby judge the state of the pixel portions.

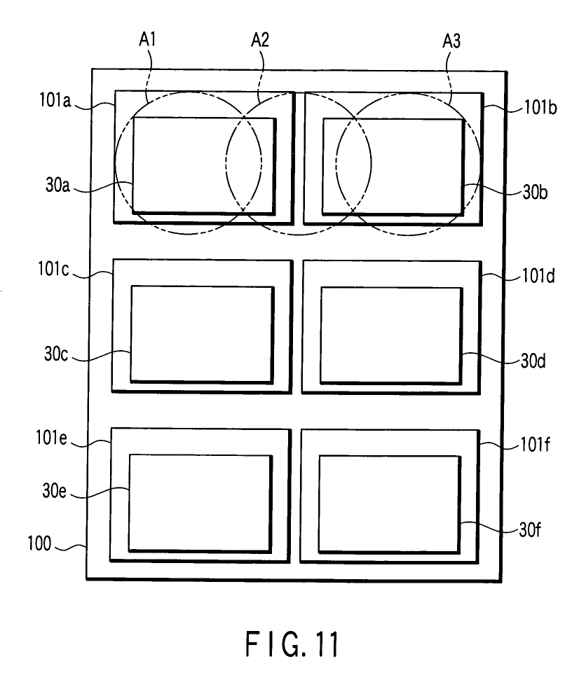

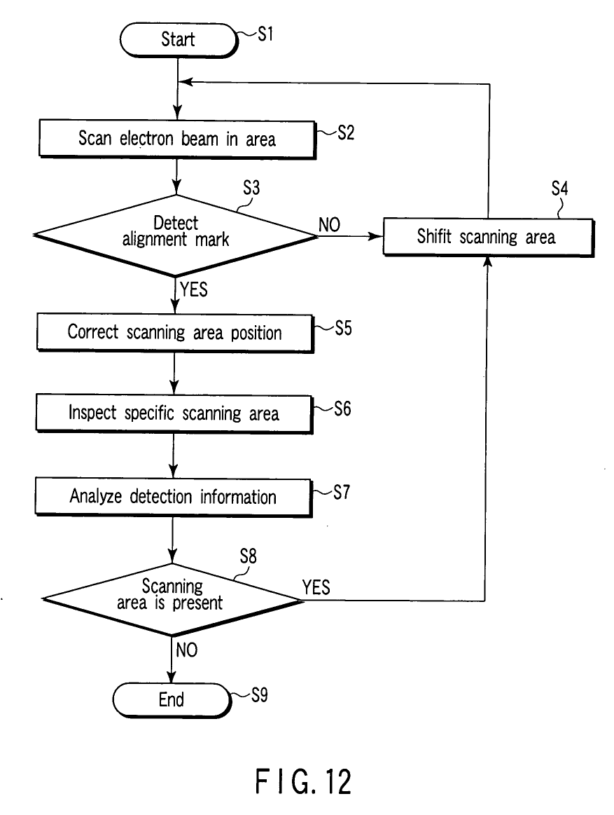

The following case will be explained with reference to FIGS. 11 and 12: when the array substrate portions 101a to 101f formed adjacent to each other on the mother substrate 100 are inspected, this inspection is carried out over pixel areas of the array substrate portions. FIG. 11 shows an example of the array substrate portions to be inspected. The array substrate portions 101a to 101f include pixel areas 30a to 30f, respectively, and the screen is large. To be more specific, it is a 17-inch diagonal screen. FIG. 12 shows an example of a flowchart set in the controlling section 324. This flow shows the procedure of inspection of the pixel portions of the array substrate portions 101a to 101f.

When inspection of the pixel portions is started (step S1), the controlling section 324 controls the electron beam scanner 300, beam scanning of a predetermined area is carried out (step S2). Secondary electrons SE are detected by the electron detector 350. Detection information is analyzed by the signal analyzing section 323, and an analysis result is sent to the controlling section 324. The controlling section 324 determines whether or not an alignment mark is detected, from the analysis result (step S3). When determining that it is not detected, the controlling section 324 controls the electron beam scanner 300 to shift the scanning area of an electron beam (step S4). It should be noted that alignment marks are formed on the mother substrate 100 or the array substrate portions. Thus, when they are detected by the EB tester, the positions of the array substrate portions and pixel portions can be specified.

When alignment marks are detected, the controlling section 324 finely adjusts the beam scanning area, thereby performing a control for causing each of the pixel portions in a first scanning area A1 to be reliably scanned in a first scanning step (step S6). At this time, secondary electrons radiated from the pixel portions in the first scanning area A1 are detected, and detection information is analyzed by the signal analyzing section 323 (step S7). It should be noted that the electron beam is radiated only onto each of the pixel portions, and is not radiated to the other area, even if the other area is located in the first scanning area dA1. This is because information indicating the structure of the array substrate proton 101a is given to the control section 324 in advance. The controlling section 324 sets a deflection area of the electron beam based on structure information on the array substrate portion 101a. After inspection information is analyzed, the controlling section 324 determines whether a pixel portion not yet scanned is present or absent (step S8).

When all the pixel portions are scanned, inspection of the pixel portions is ended (step S9). When a pixel portion not scanned is present, the controlling section 324 adjusts the electron beam scanner 300 (step S4), and beam scanning of a predetermined area is carried out (step S2). At this time, it is determined whether an alignment mark is detected or not. When it is determined that it is detected, a control is performed such that pixel portions in a second scanning area A2 are reliably scanned (step S6).

When the pixel portions in the second scanning area A2 are inspected, inspection is performed over the two array substrates 101a and 101b. That is, in the array substrate 101a, the pixel portions located in the second scanning area A2 are inspected, and in the array substrate 101b, the pixel portions in the second scanning area are also inspected. It should be noted that the first scanning area A1 and the second scanning area A2 partially overlap each other in the array substrate 101a, and after inspection of the pixel portions in this overlapping area is performed one time, it is not repeated. They are inspected in any of the first and second scanning steps. Information on the above inspection information is analyzed by the signal analyzing section 323 (step S7).

Thereafter, the electron beam scanner 300 is adjusted (step S4), and beam scanning of a predetermined area is performed (step S2). Then, when alignment marks are detected, a control is performed such that the pixel portions in a third scanning area A3 are reliably scanned as in a third scanning step (step S6). In the third scanning step, the pixel portions other than the pixel portions inspected in the second scanning step are inspected, and thus only the pixel portions not yet inspected in a pixel area 30b are inspected. Information on the above inspection is analyzed by the signal analyzing section 323 (step S7).

As described above, the pixel portions of the array substrate portions 101a to 101b are inspected. Then, similarly, the pixel portions of the array substrate portions 101c to 101f are inspected, and inspection of all the array substrate portions located on the mother substrate 100 ends.

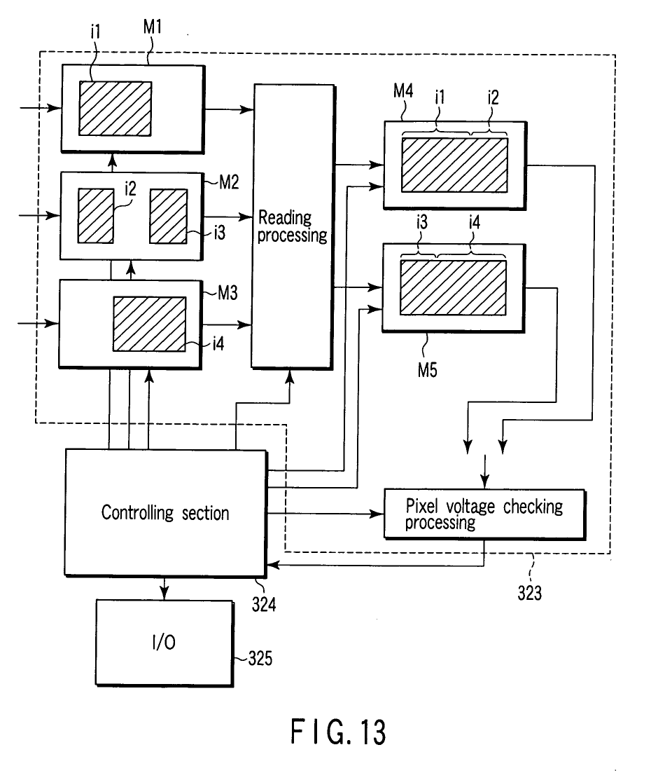

Processing of the inside of the signal analyzing section 323 and the controlling section 324 in the first to third scanning steps will be explained with reference to FIG. 13. The signal analyzing section 323 includes a plurality of memory sections, e.g., a first memory section M1 to a fifth memory section M5.

In the first scanning step, when the pixel portions are inspected, information on the pixel portions is stored as first scanning information i1 in the first memory section M1. Then, in the second scanning step, when the pixel portions are inspected, information on the pixel portions is stored as second scanning information i2 and third scanning information i3 in the second memory section M2. The first scanning information i1 and second scanning information i2 stored in the above memory sections are read therefrom in response to a control signal from the controlling section 324, and then stored in the fourth memory section M4. Consequently, the scanning information on all the pixel portions of the pixel area 30a is stored in the fourth memory section M4. The scanning information in the fourth memory section M4 indicates the states of the pixel portions. Then, the voltages of the pixel portions are checked in order to inspect the states of the pixel portions. This checking is carried out in response to a control signal from the controlling section 324, and the checked information of the pixel portions is sent to the input/output section 325 through the controlling section.

Thereafter, in the third scanning step, when the pixel portions are scanned, information on the pixel portions is stored as fourth scanning information i4 in the third memory section M3. The third scanning information i3 and fourth scanning information i4 stored in the second memory section M2 and third memory section M3 are read therefrom in response to a control signal from the controlling section 324, and then stored in the fifth memory section M5. Consequently, the scanning information on all the pixel portions of the pixel area 30b is stored in the fifth memory section M5. The scanning information in the fifth memory section M5 indicates the states of the pixel portions. Then, the voltages of the pixel portions are checked in order to inspect the states of the pixel portions. This checking is carried out in response to a control signal from the controlling section 324, and the checked information on the pixel portions is sent to the input/output section 325 through the controlling section.

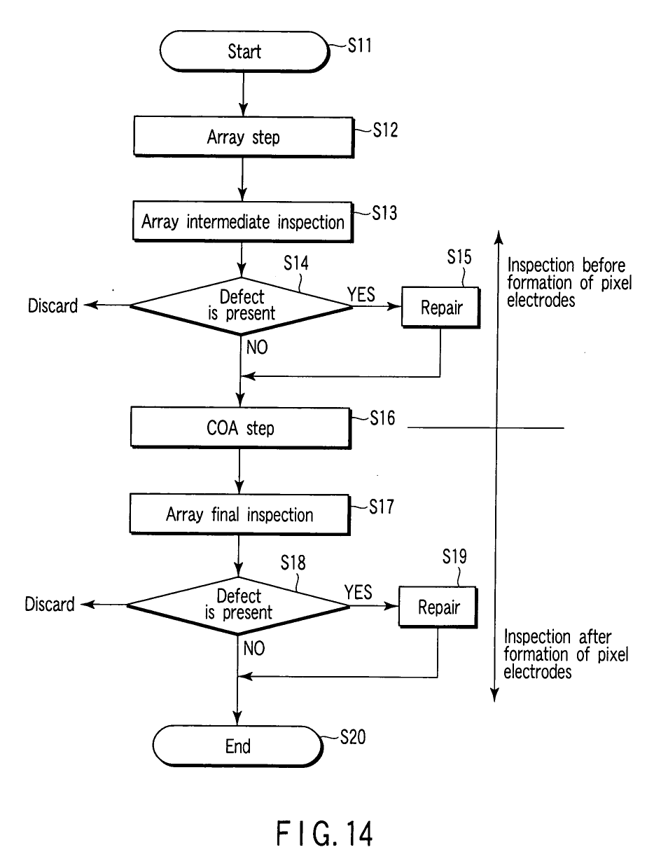

A process of inspecting the array substrate portion 101 in two steps will be roughly explained with reference to FIG. 14. In a step S11, when inspection of the array substrate starts, the array substrate portion 101 before formation of a color filter is formed in a step S12 as an array step. Then, the array substrate portion 101 is inspected by the electrical tester in a step S13 as an array intermediate inspection. Inspection in this stage is performed by using the probe unit 340 shown in FIG. 10. In the step S14, if it is detected that the array substrate portion 101 is defective, it is sent to a repairing step of repairing the array substrate portion (step S15) or a discarding step.

When the array substrate portion 101 is not defective, or it is subjected to repairing processing, the step to be carried out is shifted to a subsequent step, i.e., a COA (color filter on array) step (step S16). In this step, a color filter and pixel electrodes P are formed at the array substrate portion 101. Then, after formation of the pixel electrodes P, the array substrate portion 101 is inspected by using an electron beam as an array final inspection in a step S17. To be more specific, electron beams are radiated onto charged pixel electrodes P, and secondary electrons radiated from the pixel electrodes are detected and analyzed, thereby inspecting whether the pixel electrodes normally holds electric charge or not. This inspection means inspection of whether the TFTs SW connected to the pixel electrodes P are defective or not, and whether the auxiliary capacity elements 131 connected to the pixel electrodes P are defective or not, in addition to whether the pixel electrodes P themselves are defective or not.

In a step S18, when it is detected that the array substrate portion 101 is defective, it is sent to a repairing step of repairing a array substrate portion (step S19) or a discarding step. The array intermediate inspection is referred to as first inspection step and the array final inspection is referred to as second inspection steps. In the case where it is detected in the step S18 that the array substrate is not defective, or it is repaired in the step S19, inspection of the array substrate ends (step S20).

Advantages of provision of the first inspection step before the second inspection step in an inspection process shown in FIG. 14 will be explained. Suppose in the case where the array substrate portion 101 is inspected only in the second inspection step, a problem is detected in the array substrate portion. For example, if it arises due to breaking of array lines such as signal lines X or scanning lines Y, the second inspection step is carried out after formation of the color filter and pixel electrodes P, and thus repairing of array lines at a lower layer cannot be performed. However, provision of the first inspection step enables such repairing to be performed, even if breaking of array lines occurs. Thus, it can be restricted that in the second inspection step, the array substrate portion 101 is sent to the discarding step. Furthermore, a defective array substrate portion 101 can be more early detected and repaired, thus improving the yield, as a result of which the manufacturing cost can be reduced.

In the above inspecting method and apparatus for inspecting the array substrate, which has the above structure, in the case where the screen size of array substrate portions 101 arranged adjacent to each other on the mother substrate 100 is 17 inches, that is, it is large, and these array substrate portions are inspected by the EB tester, they are done such that inspection is carried out over two adjacent substrate portions. In the case of inspecting the two array substrate portions 101 without scanning the electron beam over those portions of the array substrate portions which are opposite to each other, it is necessary to perform scanning of the electron beam four times. In the case of inspecting the two array substrate portions 101 while scanning the electron beam over the above portions of the array substrate portions, it suffices that scanning of the electron beam is performed three times. Thus, when inspection is carried out such that it is done over two adjacent array substrate portions, the time required for inspecting the array substrate portions can be reduced. When the number of times the electron beam EB is scanned is reduced, that of times alignment marks are detected is also reduced, and the inspection time period can be further shortened. The positions of alignment marks formed on the mother substrate 100 are detected by the EB tester, as a result of which the positions of the pixel portions on the substrate can be grasped. Thus, inspection of the states of the pixel portions can be performed, with the positions of the pixel portions grasped in advance.

Furthermore, in the case where the array substrate portion 101 is inspected in two steps, the inspection time period is increased. However, inspection is performed over a plurality of array substrate portions formed on the mother substrate 100, as a result of which recovery can be also performed with respect to the time period required for complete inspection. When inspection of the array substrate portions is performed, defects in pixel portions can be detected. Therefore, defective liquid crystal display devices are prevented from appearing as a product on the market.

It should be noted that the present invention is not limited to the above embodiment, and various modifications may be made within the scope of the invention. For example, when inspection is performed over array substrate portions arranged adjacent to each other on the mother substrate 100, the array substrate portions 101a and 101c may be also inspected (see FIG. 11). It suffices that array substrate portions located in the range of radiation of the electron beam are inspected. In the case where the screen size of the array substrate portions 101 arranged adjacent to each other on the mother substrate 100 is 17 inches or more, it is also effective, that is, it suffices that inspection can be performed over two array substrate portions. On the other hand, in the case where the screen size of the array substrate portions 101 arranged adjacent to each other on the mother substrate 100 is 15 inches or less, it is also effective, that is, it suffices that inspection can be performed over portions or the entire of two or more array substrate portions. In addition, in the case where the screen size of the array substrate portions 101 fails within the range of 15 inches to 17 inches, it is also effective. The above is true of the case where different kinds of array substrate portions 101 or a plurality of array substrate portions 101 having different sizes are arranged adjacent to each other on the mother substrate 100.

What is claimed is:

1. A method for inspecting a substrate comprising a mother substrate, a first array area and a second array area which are formed on the mother substrate and opposed to each other with respect to a line intended for division, and each of which includes scanning lines, signal lines, switching elements close to intersections of the scanning lines and the signal lines, and pixel electrodes connected to the switching elements, the method comprising:
radiating electron beams onto a radiation area which includes at least part of the first array area and at least part of the second array area, with a relative positional relationship between the mother substrate and the beam source being fixed at the same time;
detecting secondary electrons radiated from the pixel electrodes; and
inspecting with respect to whether the pixel electrodes are defective or not based on the detected secondary electrons.

2. A method for inspecting mother substrate, in which a plurality of array substrate portions are formed in the mother substrate and include pixel areas in which scanning lines and signal lines are formed to intersect each other, a plurality of pixel portions are respectively formed close to intersections of the scanning lines and the signal lines, a scanning line driving circuit is formed for supplying drive signals to the pixel portions, a signal line driving circuit is formed for supplying drive signals to the pixel portions, and group of pads connected to the scanning line driving circuit and the signal line driving circuit, the method comprising:
radiating electron beams with electron beam scanning at a radiation range in which the beam scanning is performed over portions of the array substrate portions which are located opposite to each other or the beam scanning is performed over all the array substrate portions at the same time; and
acquiring inspection information on the pixel portions of the array substrate portions which are located in the radiation range.

3. The method according to claim 2, wherein in a case where inspection information on pixel portions of array substrate portions whose pixel area is larger than the radiation range is acquired, after inspection information on pixel portions of an area of an array substrate portion of the array substrate portions is acquired, inspection information on pixel portions of a remaining area of the array substrate portion and inspection information on pixel portions of an area of other array substrate portion of the array substrate portions located adjacent to the array substrate portion are together acquired.

4. The inspecting method according to claim 3, further comprising:
forming color filters at the array substrate portions, after the inspection information on the pixel portions is acquired, and inspection of the pixel portions of the array substrate portions completes.

5. An apparatus for inspecting mother substrate, in which a plurality of array substrate portions are formed in the mother substrate and include pixel areas in which scanning lines and signal lines are formed to intersect each other, a plurality of pixel portions are respectively formed close to intersections of the scanning lines and the signal lines, a scanning line driving circuit is formed for supplying drive signals to the pixel portions, a signal line driving circuit is formed for supplying drive signals to the pixel portions, and group of pads connected to the scanning line driving circuit and the signal line driving circuit, the apparatus comprising:
an electron beam scanner for radiating electron beams with electron beam scanning at a radiation range in which the beam scanning is performed over portions of the array substrate portions which are located opposite to each other or the beam scanning is performed over all the array substrate portions at the same time; and
signal analyzing section for acquiring inspection information on the pixel portions of the array substrate portions which are located in the radiation range.

6. The apparatus according to claim 5, wherein the array substrate portions are larger than the radiation range and the signal analyzing section further comprises:
first memory section for acquiring inspection information on pixel portions of an area of an array substrate portion of the array substrate portions;
second memory section for acquiring inspection information on pixel portions of a remaining area of the array substrate portion, and together inspection information on pixel portions of an area of other array substrate portion of the array substrate portions located adjacent to the array substrate portion.
